(19) United States
(12) Patent Application Publication
(10) Pub. No.: US 2014/0138320 A1
(43) Pub. Date: May 22, 2014

(54) AGENT FOR REMOVING PHOSPHORUS COMPOUNDS FROM WATER

(71) Applicant: ZACHODNIOPOMORSKI UNIWERSYTET TECHNOLOGICZNY W SZCZECINIE, Szczecin (PL)

(72) Inventors: Hanna SIWEK, Szczecin (PL); Malgorzata WLODARCZYK, Szczecin (PL); Artur BARTKOWIAK, Szczecin (PL); Katarzyna SOBECKA, Szczecin (PL)

(73) Assignee: Zachodniopomorski Uniwersytet Technologiczny w Szczecinie, Szczecin (PL)

(21) Appl. No.: 13/849,287

(22) Filed: Mar. 22, 2013

(30) Foreign Application Priority Data
Nov. 20, 2012 (PL) PL401689

(51) Int. Cl. C02F 1/28

(52) U.S. Cl. CPC C02F 1/288
USPC 210/681; 252/176

(57) ABSTRACT

Agent for removing dissolved phosphorus compounds from water according to the invention, containing a biopolymer and metal compound, is characterized by being in the form of spherical capsules which contain the biopolymer or derivatives thereof with the ionic character crosslinked in the presence of at least one water-soluble polyvalent metal compounds.

### CROSS-REFERENCE TO RELATED APPLICATIONS

This application claims benefit of Polish Patent Application PL 401689, filed Nov. 20, 2012, and incorporates said Polish application by reference in its entirety.

### FIELD OF THE INVENTION

The present invention relates to the field of water reclamation and purification and, in particular, a method for the removal of dissolved phosphorous compounds from water.

### BACKGROUND

Monitoring and experimental studies have been carried out for many years on the reasons and the rate of eutrophication of aquatic ecosystems. They revealed that, in the majority of cases, the content of phosphorus remains the primary factor controlling excessive growth of plankton organisms in water. A deficiency of this element in the aquatic environment leads to significant limitation of biomass growth, whereas an excess usually accelerates this process. The eutrophy of a lake is determined not only by the total phosphorus content in water, but also by the composition of the water column and bottom sediments as well as the availability of phosphate ions which could be assimilated by living organisms.

Several well-known and used methods, including mechanical, biological and chemical processes, are available for reducing the availability of bio-assimilable forms of phosphorus in aquatic ecosystems. Chemical methods rely on introducing into the water column, or in the bottom sediments, certain substances that cause binding of dissolved phosphorus compounds. For this purpose, substances containing multivalent metals are primarily used in the form of the following compounds: Al(OH)₃ [Tandyrak et al., LIMNOLOGICAL REVIEW 1:263 (2001)], Al₂(SO₄)₃ [Hullebusch et al., ENVIRONMENTAL POLLUTION 120:617 (2002)], CaCO₃, Ca(OH)₂ [Dittrich and Koschel, HYDROBIOLOGIA 469:49 (2002); Prepaset al., ENVIRON. SCI. TECHNOL. 24(8):1252-1258 (1990)], Fe₂(SO₄)₃, FeSO₄ [Perkins and Underwood, WAT. RES. 35(6):s.1399-1406 (2000]; also, with regard to use of FeCl₃ FeCl₂; Wiśniewski, LAKES & RESERVOIRS RESEARCH AND MANAGEMENT 4: 65-73, (1999); Deppe, Benndorf, WATER. RES. 36(18) (2002)] or, in the form of double salts FeClSO₄ [Jaeger, HYDROBIOLOGIA 1:433-444 (1994)].

Among the above-mentioned compounds, the iron compounds, which exhibit a double-action type mechanism, are the most frequently used. The first action of the mechanism relies on the hydrolysis of iron compounds to form hydroxides, which proceeds most intensively at elevated pH. The iron hydroxides produced at the appropriate high redox potential (greater than 200 mV) form insoluble complexes and absorb phosphorus compounds while settling at the bottom. The second action of the mechanism of phosphate ion sorption relies on the precipitation of sparingly soluble iron (III) phosphates (V), whereas the amount of phosphorus bound in this way is a number of times smaller than the amount of phosphorus absorbed by the hydroxides.

Because the coagulation processes in natural waters are accompanied by the adsorption process of different forms of phosphorus, the mineral sorbents are added to water, for instance, goethite FeOOH, in order to increase their rate and to decrease the desorption of phosphorus compounds from the bottom sediments [Geelhoed et al., GEOCHEMICA ET COSMOCHEMICA ACTA 61:2389-2396 (1997)]. Moreover, the waste containing iron, for instance, iron powder and iron(III) oxide, have also been investigated [Chitrakar et al., JOURNAL OF COLLOID AND INTERFACE SCIENCE 298:602 (2005)]. Another widely promoted adsorbent is tradenamed “Phoslock”, which is mainly composed of bentonite (about 95% of the product) that has lanthanum embedded therein (forming about 5% of the product) EP1012123, U.S. Pat. No. 6,350,383, Haghseresht et al., Applied Clay Science 46(2): 369-375 (2009). The Phoslock product combines with phosphorus and forms a stable compound known as rhabdophane (EP1012123B1). Other adsorbents based on bentonite have also been prepared in the form of beads or pastes (for instance, preparations under the general name SINOBENT, which are the subject of Polish patent application P.388253.

The sorption properties of natural polysaccharides in the form of hydrogel capsules, for instance, calcium alginate, have been confirmed, e.g. in the research concerning the purification of water from radionuclides [Mimura et al., J. RADIOANAL. NUCL. CHEM. 247(2):375 (2001)] and heavy metals [Nayak and Lahiri, J. RADIOANAL. NUCL. CHEM. 267:59 (2006)]. Biosorbents which contain the carboxylic groups in their structure are characterized by a natural affinity for cations. However, after the chemical modification relying on incorporation of multivalent metal ions into their surface structure, the biopolymers are transformed into an adsorbent with anion sorption capacity.

Adsorbents for removing oxyanions containing Se (IV) and As (V) from water were prepared by incorporating Fe (III) into the surface structure of calcium alginate. [Min and Hering, WATER ENVIRON. RES. 71:169-175 (1999)]. The only system of such type for the adsorption of phosphate ions from the aqueous phase known to applicant is an alginate/zirconium sulphate matrix. This matrix has been shown to have better sorption capacity than zirconium sulphate in a powdered form [Yeon et al., KOREAN J. CHEM. ENG. 25(5):1040 (2008)]. A very high price of zirconium salt and a complex technology for the preparation of systems thereof, requiring the application of surfactants, significantly restricts the possibility of practical utilization of said solution. The research carried out in the case of other biosorbents confirmed that the immobilization of iron in their structure significantly enhances the affinity of phosphate ions for these biopolymers [Eberhardt et al., Bioresour. Technol. 97:2371 (2006); Eberhardt and MIN, BIORESOUR. TECHNOL. 99:626 (2008)].

In view of the technologies for removing phosphorous-containing compounds from water found in the prior art, there remains a need for more efficient, less expensive approaches for reclaiming water.

### SUMMARY OF THE INVENTION

An agent for removing dissolved phosphorus compounds from water comprises at least one biopolymer and at least one metal compound, wherein said agent has the form of a sphere shaped capsule and said metal compound is polyvalent.

A method of preparing an agent for removing phosphorus compounds from water comprises, adding a biopolymer into a solution of a polyvalent metal compound and stirring, wherein drop-wise addition of the biopolymer is drop-wise and the stirring at a is constant rate forms capsules.

### BRIEF DESCRIPTION OF THE DRAWINGS

FIG. 1 is a bar graph representing data generated measuring adsorption of phosphate by the alginate/FeCl₃ adsorbent of the present invention at various pH levels typical for naturally sourced water.

FIG. 2 is a bar graph representing data generated measuring the effect of pH on the adsorption of phosphate ions by goethite and the alginate/goethite matrix.

### DETAILED DESCRIPTION OF THE INVENTION

The objective of the present invention is to provide a pro-environmental agent for binding dissolved phosphorus compounds with the contribution of polyvalent metal ions immobilized in the structures of biopolymer substrates having an ionic character.

Said agent for the removal of dissolved phosphorus compounds from water, according to invention, containing a biopolymer and metal compound, is characterized by being in the form of spherical capsules which contain the biopolymer or derivatives thereof with the ionic character cross-linked in the presence of at least one water-soluble polyvalent metal compound. During the crosslinking, a polyvalent metal ion is immobilized in the structure of biopolymer with the ionic character or derivatives thereof.

Preferably said spherical capsule has additionally immobilized at least one polyvalent metal compound which is sparingly water soluble in order to increase the phosphate ions binding capacity of said capsule. Sparingly soluble is approximately 0.03 g/mL to about 0.01 g/mL.

Preferably said biopolymer or derivatives thereof with the ionic character contain the naturally occurring polysaccharides classified to the groups of so-called extracted from see algae, that is, alginate, pectin, agar and/or carrageenons (kappa, iota and lambda differing in the degree of substitution by the sulfonic groups). Also plausible is application of other polysaccharides gelling under the influence of polyvalent metal cations such as, for example, microbiologically-sourced welan, gellan and/or xanthan and the like. Alternative biopolymers extracted from derived from other organism such as plants and legumes may include guar gum, locust bean gum, and acacia gum. Additional biopolymers may include any polymer produced by a living organism, including, but not limited to: polylactic acid (PLA), naturally occurring zein, poly-3-hydroxybutyrate, biopolymers derived from renewable biomass sources, such fats as vegetable and oils, corn starch, pea starch or microbiota, Polyhydroxyalkanoates (PHA), Polyamide 11 (PA 11), bio-derived polyethylene, or genetically modified bioplastics. Alternatively, synthetic polymers that are biodegradable may be substituted for the biopolymers, which may form a hydrogel matrix.

A water soluble polyvalent metal compound is calcium bicarbonate and/or calcium chloride and/or calcium nitrate(V) and/or calcium acetate and/or calcium oxalate and/or calcium formate and/or iron(III) chloride and/or iron(II) and/or iron(III) nitrate(V) and/or iron(II) nitrate(V) and/or iron(III) sulphate(VI) and/or iron(II) and/or iron(II) sulphate(VI) and/or iron(II) oxalate and/or iron(II) acetate and/or iron(III) oxalate and/or zinc sulphate(VI) and/or zinc chloride and/or zinc nitrate(V) and/or zinc acetate.

A sparingly water-soluble polyvalent metal compound is calcium carbonate and/or calcium hydroxide and/or iron(II) carbonate and/or manganese(II) carbonate and/or manganese(II) hydroxide and/or manganese(II) oxide and/or oxides and/or hydroxides of iron: magnetite, hematite limonite, goethite.

Said biopolymer or derivatives thereof constitutes a matrix for the metal ions. In one embodiment, the prepared hydrogel matrixes are alginate/polyvalent metal cation or κ-carrageenon/polyvalent metal cation or xanthan/polyvalent metal cation or gellan/polyvalent metal cation. The agent is prepared by a drop-wise addition method in one embodiment. The capsules are formed through the drop-wise addition of a solution of biopolymer or derivatives thereof with the ionic character into the solutions of bonded metal salts. The hydrogel matrixes containing the polyvalent metal compounds insoluble in water are prepared through the preparation of a suspension of immobilized compound and stirring of this suspension with biopolymer solution. Subsequently, the obtained mixture is injected in the form of separate droplets into a solution of gelling salt. The hydrogel matrixes containing the polyvalent metal compounds insoluble in water are prepared through the cross-linking of sodium alginate solution and ic-carrageenon in the presence of at least one polyvalent metal compound dissolved in water. In both cases, after the injection of the last drop of suspension, the formed capsules are stirred at a constant stirring rate ranging from about 400 rpm to about 800 rpm, with a range preferably between about 500 rpm and 700 rpm, over a period from about 5 minutes to about 30 minutes and then the capsules are washed in distilled water. Although the application of shorter reaction time is possible, such systems are most often characterized by an incomplete degree of saturation/binding of cross-linking metal cations. The application of cross-linking time of more than about 30 minutes does not influence in a substantial way the improvement in utility properties of obtained spherical hydrogels. The spherical capsules may be between about 0.2 mm to about 10 mm.

The main advantage of described invention is primarily the multifunctionality, high effectiveness and the long-term performance over a wide pH range and the oxidation-reduction potential. With the application of said agent, the binding of phosphorus may proceed via (i) adsorption of soluble and insoluble forms of phosphorus on the porous structure of capsules activated by immobilized metal ions or polyvalent metals and (ii) via the gradual release of said ions. The second of the above-mentioned mechanisms may ensure a constant gradient of the coagulant concentrations in over-bottom layer and may shift the equilibrium of dissolution and precipitation reactions of phosphates. In the proposed method, a polymer network of polyelectrolyte complex in the form of spherical capsules may contain the anionic groups with different character, both strong sulfo groups as well as and/or the weak carboxyl groups, owing to which the kinetics of adsorption and desorption of the components may be controlled in a various way through the quantitative changes of components, for instance, the rate of release of the metal ions may be initially high and later significantly slower.

In contrast to the best absorbents and coagulants currently is use, the application of proposed matrix creates a potential possibility of various formation of substrate and the removal of said substrate from the aquatic environment in whichever time. An additional advantage of said substrate is its capability to limit resuspension of sediments.

The present invention provides a totally biodegradable agent the components of which contain the substances naturally occurring in the aquatic environment. The agent acts practically in the same way independently on the value of pH within the range of pH determined in natural water basin. Said agent also acts under the reduction conditions, even at the redox potential of less than about 200 mV. During the application of traditional coagulants and adsorbents, the reduction of Fe³⁺ to Fe²⁺ already proceeds at the redox potential <300 mV, which leads to the desorption of phosphate ions. Differently than other adsorbents said agent limits the sediments resuspension, but it does not form the impermeable layer of adsorbent on the sediment surface. In case of other adsorbents, such layer renders the gaseous exchange between the water and sediment difficult and this layer has an unfavorable influence on the organisms living in the bottom zone, and frequently changes the biological character of remediated water basin. The agent according to the invention may be freely formed, which allows for the optional removal thereof together with the adsorbed phosphorus from the aquatic environment for regeneration of said agent. The state of the art indicates that in case of all agents proposed so far, there are no possibilities for removal thereof from the aquatic environment.

In comparison to the most effective among described absorbents, i.e., the bentonite/lanthanum-containing product discussed above as the Phoslock product, the proposed agent is cheaper and the resources of intermediates for the manufacture of said agent are practically unlimited. Said agent is safe for transport and may by easily introduced into the water column. Many currently used coagulants, for instance, iron (III) chloride solution, exhibit corrosive action against the feeder device.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

In particular, Examples I to IX illustrate the preparation of agent which is cross-linked by at least one water-soluble polyvalent metal compound; Examples X to XVIII illustrate the preparation of said agent cross-linked by a water-soluble compound and additionally containing at least one sparingly soluble compound; Example XIX illustrates the influence of agent containing different biopolymers or polyvalent metals on the phosphate concentration in water; Example XX illustrates the binding of phosphate ions using alginate/FeCl₃ and alginate/goethite agent; Example XXI illustrates the effect of pH on the adsorption of phosphate ions in water; Example XXII illustrates the influence of the redox potential on the adsorption of the phosphate ions in water with the use of alginate/FeCl₃ agent.

### Example I

Preparation of hydrogel matrix containing water-soluble polyvalent metal compounds, namely compounds formed by the alginate/FeCl₃ system (alginate cross-linked with FeCl₃).

The hydrogel capsules are prepared by the drop-wise addition of a sodium alginate solution with the molecular weight higher than about 100,000 g/mol and a concentration of about 1.5% into a solution of iron (III) chloride at a concentration of about 0.062 mol·dm⁻³. During the formation of capsules, the iron (III) chloride solution is continuously stirred at a constant stirring rate of about 600 revolutions per minute. The capsules formed in this way have a diameter ranging between about 2.5 mm and about 3.5 mm.

### Example II

The hydrogel capsules prepared in the same manner as in Example I, wherein a solution of iron (III) chloride is used at a concentration of about 0.775 mol·dm⁻³. The capsules formed in this way have the diameter ranging between about 2.5 mm and about 3.5 mm.

### Example III

The hydrogel capsules prepared in the same manner as in Example I, wherein a solution of iron (III) chloride is used at a concentration of about 0.155 mol·dm³. The capsules formed in this way have the diameter ranging between about 2.5 mm and about 3.5 mm.

### Example IV

Preparation of a hydrogel matrix containing water-soluble polyvalent metal compounds, namely compounds formed by the alginate/ZnCl₂/FeCl₃ system. The hydrogel capsules are prepared by the drop-wise addition of a sodium alginate solution at a concentration of about 1.5% into a ZnCl₂ and FeCl₃ solution, in which the concentration of each salt amounted to about 0.062 mol·dm⁻³. During the formation of capsules, the ZnCl₂ and FeCl₃ solution is continuously stirred at a constant stirring rate of about 600 revolutions per minute. The capsules formed in this way have the diameter ranging between about 2.5 mm and about 3.5 mm

### Example V

Preparation of a hydrogel matrix containing water-soluble polyvalent metal compounds, namely compounds formed by the alginate/ZnSO₄ system.

The hydrogel capsules are prepared by the drop-wise addition of a sodium alginate solution at a concentration of about 1.5% into ZnSO₄ solutions at a concentration of about 0.155 mol·dm⁻³ (alternatively at concentrations of about 0.062 mol·dm⁻³ and about 1 mol·dm⁻³). During the formation of capsules, the ZnSO₄ solution is continuously stirred at a constant stirring rate of about 600 revolutions per minute. The capsules formed in this way have a diameter ranging between about 2.5 mm and about 3.5 mm.

### Example VI

Preparation of a hydrogel matrix containing water-soluble polyvalent metal compounds, namely compounds formed by the κ-carrageenon/FeCl₃ system.

The hydrogel capsules are prepared by the drop-wise addition of a κ-carrageenon solution at a concentration of about 1.5% (alternatively at a concentration of about 2%) into the FeCl₃ solutions at a concentration of about 0.155 mol·dm⁻³ (alternatively at concentrations of about 0.062 mol·dm⁻³ and about 0.775 mol·dm⁻³). During the formation of capsules, the FeCl₃ solution is continuously stirred at a constant stirring rate of about 600 revolutions per minute. The capsules formed in this way have the diameter ranging between about 2.5 mm and about 3.5 mm.

### Example VII

The preparation of a hydrogel matrix containing water-soluble polyvalent metal compounds, namely compounds formed by the alginate/κ-carrageenon/FeCl₃ system.

A solution of κ-carrageenon at a concentration of about 1.5% and a solution of alginate at a concentration of about 1.5% are prepared and both solutions are then mixed together at a constant stirring rate of about 600 revolutions per minute. The hydrogel capsules are prepared by the drop-wise addition of the obtained solution of κ-carrageenon and alginate into the FeCl₃ solutions at a concentration of about 0.155 mol·dm⁻³ (alternatively at concentrations of about 0.062 mol·dm⁻³ and about 0.775 mol·dm⁻³). During the formation of capsules the FeCl₃, solution is continuously stirred at a constant stirring rate of about 600 revolutions per minute. The capsules formed in this way have a diameter ranging between about 2.5 mm and about 3.5 mm.

### Example VIII

Preparation of a hydrogel matrix containing water-soluble polyvalent metal compounds, namely compounds formed by the xanthan/FeCl₃ system.

The hydrogel capsules are prepared by the drop-wise addition of xanthate solution at a concentration of about 1.5% into the FeCl₃ solutions at concentration of about 0.155 mol·dm⁻³ (alternatively at concentrations of about 0.062 mol·dm⁻³ and about 0.775 mol/dm³). During the formation of capsules, the FeCl₃ solution is continuously stirred at a constant stirring rate of about 600 rpm. The capsules formed in this way have irregular shapes close to a sphere with the diameter ranging between about 2.5 mm and about 3.5 mm.

### Example IX

Preparation of a hydrogel matrix containing polyvalent metal compounds soluble in water, namely compounds formed by the gellane/FeCl₃ system.

The hydrogel capsules are prepared by the drop-wise addition of gellane solution at a concentration of about 1.5% into the FeCl₃ solutions at a concentration of about 0.155 mol·dm⁻³ (alternatively at concentration of about 0.062 mol·dm⁻³ and about 0.775 mol·dm⁻³). During the formation of capsules, the FeCl₃ solution is subjected to a continuous stirring at constant revolutions of about 600 rpm. The capsules formed in this way are characterized by a disk-like shape with a diameter ranging between about 3 mm and about 5 mm and a height from about 1 mm to about 2 mm.

### Example X

Preparation of a hydrogel matrix containing polyvalent metal compounds that are sparingly soluble in water, namely compounds of an alginate/goethite suspension cross-linked with CaCl₂.

The hydrogel capsules are prepared by the drop-wise addition of a suspension which is composed of about 1.5% of sodium alginate and goethite (at the rate of 3 to 4) with a content of 2 g goethite in 100 ml mixture thereof into a CaCl₂ solution at a concentration of about 0.155 mol·dm⁻³. The obtained capsules are stirred over a period of about 15 minutes and washed with distilled water twice for about 10 minutes. The capsules formed in this way have a diameter ranging between about 2.5 mm and about 3.5 mm and have an intensive dark brown color that is characteristic of goethite. At the same time, a decrease in the flexibility of obtained capsules is observed.

### Example XI

Agent prepared in the same manner as in Example X, wherein said goethite is used in the amount of about 6 g in 100 ml of mixture thereof. The capsules formed in this way have a diameter ranging between about 2.5 mm and about 3.5 mm and have an intensive dark brown color characteristic of goethite. At the same time, a decrease in flexibility of obtained capsules is observed.

### Example XII

Agent prepared in the same manner as in Example X, wherein said goethite is used in the amount of 10 g in 100 ml of mixture thereof. The capsules formed in this way have the diameter ranging between about 2.5 mm and about 3.5 mm and have an intensive dark brown color characteristic of goethite. At the same time, a decrease in the flexibility of obtained capsules is observed along with an increase in the amount of applied goethite.

### Example XIII

Preparation of a hydrogel matrix containing sparingly-water-soluble polyvalent metal compounds, namely compounds of the alginate/CaCO₃ suspension cross-linked with ZnSO₄ solution.

The hydrogel capsules are obtained by preparing a suspension which is composed of about 1.5% sodium alginate solution and CaCO₃ with a content of about 0.5 g (alternatively, about 0.1 g or 0.2 g or 1 g) in about 100 ml of the alginate solution and said suspension is added drop wise into a ZnSO₄ solution at a concentration of about 0.155 mol·dm⁻³. The obtained capsules are stirred over a period of about 15 minutes and washed with distilled water twice for about 10 minutes. The capsules formed in this way have a diameter ranging between about 2.5 mm and about 3.5 mm.

### Example XIV

Preparation of a hydrogel matrix containing water-sparingly-soluble polyvalent metal compounds, namely compounds formed from an alginate/CaCO₃ suspension cross-linked with a FeCl₃ solution.

The hydrogel capsules are obtained by preparing a suspension which is composed of about 1.5% sodium alginate solution and CaCO₃ with a content of about 0.5 g (alternatively, about 0.1 g or about 0.2 g or about 1 g) in about 100 ml of the alginate solution and said suspension is added drop wise into a FeCl₃ solution at a concentration of about 0.155 mol·dm⁻³. The obtained capsules are stirred over a period of about 15 minutes and washed with distilled water twice for 10 minutes. The capsules formed in this way have the diameter ranging between about 2.5 mm and about 3.5 mm.

### Example XV

Preparation of a hydrogel matrix containing sparingly-water-soluble polyvalent metal compounds, namely compounds formed from an alginate/CaCO₃/MnO₂ suspension cross-linked with a ZnSO₄ solution.

The hydrogel capsules are obtained by preparing a suspension which is composed of about 1.5% sodium alginate solution and CaCO₃ and MnO₂ (1:1) with a content of about 0.5 g of each compound in about 100 ml of the alginate solution and said suspension is added drop wise into a ZnSO₄ solution at a concentration of about 0.155 mol·dm⁻³. The obtained capsules are stirred over a period of about 15 minutes and washed with distilled water twice for about 10 minutes. The capsules formed in this way have a diameter ranging between about 2.5 mm and about 3.5 mm.

### Example XVI

Preparation of a hydrogel matrix containing water-sparingly-soluble polyvalent metal compounds, namely compounds formed by an alginate/Fe₂O₃/MnO₂ suspension cross-linked with a ZnSO₄ solution.

The hydrogel capsules are obtained by preparing a suspension which is composed of about 1.5% sodium alginate solution and MnO₂ and Fe₂O₃ (1:6) with a content of about 0.857 g Fe₂O₃ and about 0.143 g MnO₂ in 100 ml of the alginate solution and said suspension is added drop wise into a ZnSO₄ solution at a concentration of about 0.155 mol·dm⁻³. The obtained capsules are stirred over a period of about 15 minutes and washed with distilled water twice for about 10 minutes. The capsules formed in this way have a diameter ranging between about 2.5 mm and about 3.5 mm.

### Example XVII

Preparation of a hydrogel matrix containing water-sparingly-soluble polyvalent metal compounds, namely compounds formed by an alginate/Fe₂O₃/MnO₂ suspension cross-linked with a FeCl₃ solution.

The hydrogel capsules are obtained by preparing a suspension which is composed of about 1.5% solution of sodium alginate and MnO₂ and Fe₂O₃ (1:6) with a content of about 0.857 g Fe₂O₃ and about 0.143 g MnO₂ in about 100 ml of the alginate solution and said suspension is added drop wise into a FeCl₃ solution at a concentration of about 0.155 mol·dm⁻³. The obtained capsules are stirred over a period of about 15 minutes and washed with distilled water twice for about 10 minutes. The capsules formed in this way have the diameter ranging between about 2.5 mm and about 3.5 mm.

### Example XVIII

Preparation of a hydrogel matrix containing water-sparingly-soluble polyvalent metal compounds, namely compounds formed by an alginate/Fe₂O₃/MnO₂ suspension cross-linked with a CaCl₂ solution.

The hydrogel capsules are obtained by preparing a suspension which is composed of about 1.5% solution of sodium alginate and MnO₂ and Fe₂O₃ (1:6) with a content of about 0.857 g Fe₂O₃ and about 0.143 g MnO₂ in about 100 ml of the alginate solution and said suspension is added drop wise into a CaCl₂ solution at a concentration of about 0.155 mol·dm⁻³. The obtained capsules are stirred over a period of about 15 minutes and washed with distilled water twice for about 10 minutes. The capsules formed in this way have the diameter ranging between about 2.5 mm and about 3.5 mm. Preparation of hydrogel matrixes resulted in sphere shaped capsules. Sphere shaped consistent with the scope of this invention includes irregularly shaped capsules close to a sphere and spherical capsules.

Characteristics of the hydrogel adsorbents obtained according to Examples I-XVIII are presented in Table 1. Selected physicochemical properties were determined using standard methods well-known in the art.

TABLE 1

| | | | | | | | | Content | |
|---|---|---|---|---|---|---|---|---|---|
| | | | | | | | | of water | |
| | | | | | | | | in | Maximum |
| | Content of salt or metals [g · 1 cm⁻³ of polysaccharide solution] | | | | | | | capsules | compression |
| Adsorbent | CaCO₃ | MnO₂ | Fe₂O₃ | getyt | Zn | Fe | Ca | [%] | strength [N] |
| alginate/FeCl₃ | — | — | — | — | — | 0.001 ÷ 0.010 | — | 98.5 | >6.5 |
| alginate/ZnSO₄ | — | — | — | — | 0.001 ÷ 0.01 | — | — | 98.1 | >2.0 |
| alginate/ZnCl₂/ | — | — | — | — | 0.001 ÷ 0.01 | 0.001 ÷ 0.010 | — | 96.9 | >2.0 |
| FeCl₃ | | | | | | | | | |
| alginate/CaCl₂/ | | | | 0.02 ÷ 0.1 | | | 0.001 ÷ 0.01 | 91.8 | >5.0 |
| goethite | | | | | | | | | |
| alginate/ZnSO₄/ | 0.067 ÷ 0.667 | — | — | — | 0.001 ÷ 0.01 | — | — | 97.0 | >2.0 |
| CaCO₃ | | | | | | | | | |
| alginate/FeCl₃/ | 0.067 ÷ 0.667 | — | — | — | — | 0.001 ÷ 0.01 | — | 98.0 | >2.0 |
| CaCO₃ | | | | | | | | | |
| alginate/ZnSO₄/ | 0.333 | 0.095 | — | — | 0.001 ÷ 0.01 | — | — | 96.4 | >2.0 |
| CaCO₃/MnO₂ | | | | | | | | | |
| alginate/ZnSO₄/ | — | 0.095 | 0.571 | — | 0.001 ÷ 0.01 | — | — | 99.0 | >2.0 |
| Fe₂O₃/MnO₂ | | | | | | | | | |
| alginate/FeCl₃/ | — | 0.095 | 0.571 | — | — | 0.001 ÷ 0.01 | — | 96.1 | >2.0 |
| Fe₂O₃/MnO₂ | | | | | | | | | |
| alginate/CaCl₂/ | — | 0.095 | 0.571 | — | 0.001 ÷ 0.01 | — | — | 98.2 | >2.0 |
| Fe₂O₃/MnO₂ | | | | | | | | | |
| κ-carrageenon/ | — | — | — | — | — | 0.001 ÷ 0.010 | — | 97.0 | >4.5 |
| FeCl₃ | | | | | | | | | |
| alginate/κ- | | | | | | 0.001 ÷ 0.010 | | 97.6 | >2.05 |
| carrageenon/ | | | | | | | | | |
| FeCl₃ | | | | | | | | | |
| xanthan/ | — | — | — | — | — | 0.001 ÷ 0.010 | — | 96.7 | >2.0 |
| FeCl₃ | | | | | | | | | |
| gellan/ | — | — | — | — | — | 0.001 ÷ 0.010 | | 98.3 | >2.0 |
| FeCl₃ | | | | | | | | | |

### Example XIX

Solutions of KH₂PO₄ were prepared at a concentration of 15 mgP·dm⁻³ using deionised water (DIW) and two natural waters originated from polymictic inland water basins (named W1 and W2, which natural waters differed in content of dissolved compounds that resulted in electrical conductivity measurements of 369 and 124 μS·cm⁻¹, respectively). The prepared solutions containing phosphate ions were placed into Erlenmeyer flasks, 50 ml each. The flasks were closed with a ground joint and weighed portions of capsules or Phoslock (0.01 g (dry matter) per flask) were added. The control samples (without the adsorbent) were prepared in the same manner. All the tests were made in triplicate. The adsorption process proceeded at a temperature of 20° C., the changes of the phosphate ions content in the solutions were studied after attaining the equilibrium state (48 h). Table 2 presents the phosphate adsorption by the hydrogel adsorbents according to the invention and by a commercial bentonite/lanthanum-composed product for binding phosphates under the trade name Phoslock. The method by which absorbents were obtained was described in the earlier examples, as indicated in the table.

TABLE 2

| | | Adsorption [mgP · | |
|---|---|---|---|
| | | g⁻¹ dry matter | |
| | | of adsorbent] | |
| | Adsorbent | W1 | W2 |
| Example III | alginate/FeCl₃ ( ) | 11.57 | 11.12 |
| Example IV | alginate/ZnCl₂/FeCl₃ | 11.82 | 7.85 |
| Example V | alginate/ZnSO₄(a concentration of | 11.62 | 8.10 |
| | ZnSO4 - 0.155 mol · dm⁻³) | | |
| Example VI | κ-carrageenon/FeCl₃(FeCl₃ | 12.40 | 12.21 |
| | concentration of about | | |
| | 0.155 mol · dm⁻³) | | |
| Example VII | alginate/κ-carrageenon/FeCl₃ | 11.92 | 11.86 |
| | (FeCl₃ concentration of about | | |
| | 0.155 mol · dm⁻³) | | |
| Example VIII | xanthate/FeCl₃(FeCl₃ concentra- | 8.57 | 7.41 |
| | tion of about 0.155 mol · dm⁻³) | | |
| Example IX | gellan/FeCl₃(FeCl₃ concentration | 7.86 | 8.32 |
| | of about 0.155 mol · dm⁻³) | | |
| Example XIV | alginate/FeCl₃/CaCO₃(CaCO₃ | 11.49 | 11.69 |
| | content of about 0.5 g) | | |
| Example XV | alginate/ZnSO₄/CaCO₃/MnO₂ | 9.47 | 8.66 |
| Example XVI | alginate/ZnSO₄/Fe₂O₃/MnO₂ | 9.32 | 9.67 |
| Example XVII | alginate/FeCl₃/Fe₂O₃/MnO₂ | 5.28 | 6.34 |
| Example XVIII | alginate/CaCl₂/Fe₂O₃; MnO₂ | 1.86 | 0.58 |
| | Phoslock | 11.20 | 11.20 |

The phosphate ions exhibit the adsorption affinity to all the adsorbents studied. The largest adsorption capacity was found for the adsorbents obtained by the gelation of the alginate solution with the solutions of ZnCl₂, ZnSO₄ or FeCl₃ salts. The alginate/FeCl₃ adsorbent bonded the discussed adsorbate from both studied solutions at a comparable level.

A similar activity in the removal of the phosphate ions from aqueous solutions was also found for the process of adsorption thereof by the multicomponent alginate/FeCl₃/CaCO₃ capsules and by Phoslock.

### Example XX

The KH₂PO₄ solutions with different content of the phosphate ions (1, 2, 4, 10, 20, 40, 80 mgPO₄·dm⁻³) were prepared from deionised water (DIW) and two natural waters originated from eutrophic inland water basins (W1, W2—differing in a content of dissolved compounds, electrical conductivity thereof was 369 and 124 μS·cm⁻¹, respectively). The prepared solutions containing the phosphate ions were measured out in 25 ml aliquots and placed into the Erlenmeyer flasks closed with ground joint and then the portions of capsules of the alginate/FeCl₃ type prepared according to Example III which dry matter amounted to 0.01 g were added. The analogous experiments were carried out by the addition of portions of capsules of the alginate/goethite type obtained according to Example X, of which dry matter amounted to 0.01 g into the prepared solutions containing the phosphate ions. The control samples without the capsules were prepared in the same manner. All the tests were made in triplicate. The adsorption process proceeds at a temperature of 20° C., the changes of the phosphate ions content in the solutions were studied after attaining the equilibrium state (48 h).

The sorption ability of hydrogel capsules was compared with the most effective agent currently used for phosphorus binding in the aquatic environment, namely with Phoslock. For this purpose, the DIW, W1 and W2 solutions containing the phosphate ions were measured out in 50 ml to the Erlenmeyer flasks closed with ground joint and Phoslock was then added to each solution in the amount of 0.0200 g. The control samples without Phoslock were prepared in the same manner, all the tests were made in triplicate. The adsorption process proceeded at a temperature of 20° C., the changes of the phosphate ion contents in the solutions were studied after attaining the equilibrium state (48 h). Table 3 presents the parameters of isotherms describing the adsorption process of the phosphate ions on the selected types of hydrogel capsules and Phoslock at temperature of 20° C.

TABLE 3

| | | | | | Langmuir* isotherm | | |
|---|---|---|---|---|---|---|---|
| | | | | | Qₘₐₓ | | |
| | | | | | [mgP · g⁻¹ s · m | | |
| | | Freundlich* isotherm | | | of | b | |
| Adsorbent | Solution | K | l/n | r | adsorbent] | [dm³ · mg⁻¹] | r |
| alginate/FeCl₃ | WD | 7.36 | 0.531 | 0.99 | 30.30 | 0.53 | 0.99 |
| | W1 | 16.98 | 0.422 | 0.95 | 43.48 | 1.92 | 1.00 |
| | W2 | 14.81 | 0.541 | 0.99 | 50.00 | 0.69 | 1.00 |
| alginate/goethite | WD | 6.08 | 0.373 | 0.97 | 18.02 | 0.76 | 0.99 |
| | W1 | 10.2 | 0.249 | 0.96 | 22.88 | 2.24 | 0.99 |
| | W2 | 11.2 | 0.279 | 0.99 | 25.58 | 1.16 | 1.00 |
| Phoslock | WD | 7.78 | 0.519 | 0.98 | 55.55 | 0.058 | 0.99 |
| | W1 | 7.88 | 0.502 | 0.97 | 55.55 | 0.117 | 0.96 |
| | W2 | 7.54 | 0.515 | 0.97 | 55.55 | 0.051 | 0.97 |

${ }^{*} Langmuir ( {q}_{e} = \frac{{bQ}_{max} {C}_{e}}{1 + {bC}_{e}} ) ; Freundlich ( {q}_{e} = {KC}_{e}^{1 / n} )$

The highest adsorption capacity for the phosphate ions among the studied hydrogel capsules exhibit the alginate/FeCl₃ capsules. The maximum amount of phosphate ions adsorbed in the natural waters per 1 g of dry matter of hydrogel capsules amounted to 43, 48 and 50.00 mgP·g⁻¹ and was comparable with the maximum adsorption of phosphate ions on Phoslock which amounted to 55.55 mgP·g⁻¹ d·m of adsorbent.

### Example XXI

Seven solutions (DIW) of KH₂PO₄ and seven aliquots of natural waters enriched with the same compound (W2) were prepared so that the concentration of each solution amounted to 10 mg [PO₄]³⁻·dm⁻³. The appropriate amounts of HCl or NaOH were added to each solution to achieve the following pH levels: 4, 5, 6, 7, 8, 9, and 10. The prepared solutions with different pH were added in various combinations in 25 ml to the Erlenmeyer flasks closed with ground joint and the portions of capsules of the alginate/FeCl₃ type prepared according to Example III, of which dry matter amounted to 0.01 g. The analogous experiments were carried out by the addition of portions of capsules of the alginate/goethite type obtained according to Example X, of which dry matter amounted to 0.01 g or by adding 0.01 g of goethite. The control samples without the capsules and goethite were prepared in the same manner. All the samples were prepared in triplicate. The content of [PO₄]³⁻ ions was measured in each sample after 48 h. The mixtures were shaken at a temperature of 20° C. for 2 hours using a laboratory shaker at both the beginning and end of the binding process of phosphate ions.

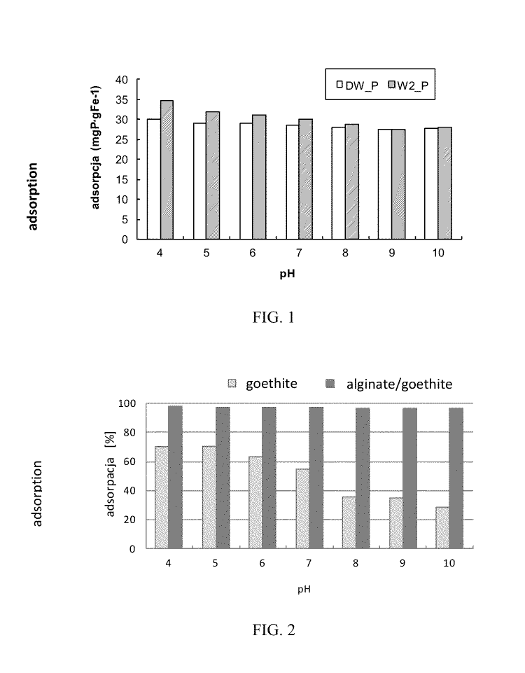

Data was generated by measuring the adsorption amount at the various pH levels, which data is presented in the bar graph of FIG. 1. The influence of pH on the binding process of phosphate ions from solutions thereof is modest but clearly identified in FIG. 1. The amount of removed phosphates decreases along with increasing pH. The presented results indicate that the alginate/FeCl₃ adsorbent removes the phosphate ions in the pH range of natural waters which amounts from 4 to 10 despite the decreasing efficiency of removal with increasing pH.

A comparison of the effect of the pH on the adsorption of phosphate ions by goethite and the alginate/goethite matrix is presented in FIG. 2. A significant decrease of the sorption affinity to the phosphate ions proceeded along with the increase of pH. The alginate/goethite capsules removed the phosphate ions at a comparable level as goethite over a wide range of pH from 4 to 10.

### Example XXII

The studies have been carried out in the system: bottom sediment/natural water enriched with KH₂PO₄ (W2) at a concentration of 10 mgPO₄·dm⁻³. A 10 g of sediment and 100 cm³ of water was added to each of the 250 ml beaker. In order to ensure the oxidative conditions the waters were saturated with oxygen, whereas by nitrogen in the case of the reductive conditions. For each combination 12 measurement series were prepared with the double repetition. The changes of the phosphate (V) ions content in the aqueous phase solutions were studied after attaining the equilibrium state. The studies concerning binding the phosphate ions with contribution of the alginate/FeCl₃ matrix were carried out in the same system, for this purpose, a portion of capsules obtained according to Example III which dry matter amounted to 0.02 was added to each beaker.

The distribution coefficient of phosphate ions between the solid and liquid phases was calculated for given examples, the results of which using the following equation are displayed below in Table 4.

$$k = \frac{{C}_{sediment}}{{C}_{water}}$$

TABLE 4

| | | | | | Distribution | |
|---|---|---|---|---|---|---|
| | | | | Redox | coefficient | |
| Redox | | Temperature | | potential | Aver- | Standard |
| conditions | System | [° C.] | pH | [mV] | age | deviation |
| Oxidative | water/ | 17.1 | 8.7 | 300.2 | 11.50 | 0.57 |
| | sediment/ | | | | | |
| | capsules | | | | | |
| | water/ | 16.3 | 8.7 | 291.8 | 0.92 | 0.19 |
| | sediment | | | | | |
| Reductive | water/ | 16.0 | 8.5 | 70.0 | 11.00 | 0.49 |
| | sediment/ | | | | | |
| | capsules | | | | | |
| | water/ | 16.3 | 8.9 | 21.9 | 0.59 | 0.19 |
| | sediment | | | | | |

The parameters of investigated processes of phosphorus binding and the distribution coefficients between the solid and liquid phases of the phosphate ions were compiled in Table 4. A significantly larger value of this coefficient was found under reductive conditions in the water/sediment/capsules system. A change of the redox conditions from oxidative to the reductive causes that the distribution coefficient decreased by about 30% in the water/sediment system, whereas a substantial change of this coefficient was not found in the case of the water/sediment/capsule system. A lack of influence of the redox potential changes on the process of phosphate ions binding with the contribution (use) of the capsules is very beneficial, because this potential is one of the fundamental factors influencing the release of readily soluble phosphorus compounds from bottom sediments. These properties indicate a considerable advantage of said agent over other coagulants and adsorbents which are used for the phosphorus binding in the water basins.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings, if any. Such modifications are intended to fall within the scope of the appended claims. All publications cited herein are incorporated by reference in their entirety.

What is claimed is:

1. An agent for removing dissolved phosphorus compounds from water comprising at least one biopolymer and at least one metal compound, wherein said agent has the form of a sphere shaped capsule and said metal compound is polyvalent.

2. The agent according to claim 1, wherein said spherical capsule has immobilized at least one sparingly water soluble polyvalent metal compound.

3. The agent according to claim 1, wherein said biopolymer is extracted from algae.

4. The agent according to claim 3, wherein said biopolymer is selected from a group consisting of alginate, κ-carrageenon, agar and pectin.

5. The agent according to claim 1, wherein said biopolymer is derived from other organisms.

6. The agent according to claim 5, wherein said biopolymer is selected from a group consisting of guar gum, locust bean gum, and acacia gum.

7. The agent according to claim 1, wherein said at least one polyvalent metal compound is water soluble and has gelling capacity of the at least one biopolymer.

8. The agent according to claim 7, wherein said water soluble polyvalent metal compound is selected from the group consisting of calcium bicarbonate, calcium chloride, calcium nitrate(V), calcium acetate, calcium oxalate, calcium formate, iron(III) chloride, iron(II), iron(III) nitrate(V), iron(II) nitrate(V), iron(III) sulphate(VI), iron(II), iron(II) sulphate(VI), iron(II) oxalate, iron(II) acetate, iron(III) oxalate, zinc sulphate(VI), zinc chloride, zinc nitrate(V) and zinc acetate.

9. The agent according to claim 2, wherein said sparingly water soluble polyvalent metal compound is selected from the group consisting of calcium carbonate, calcium hydroxide, iron(II) carbonate, manganese(II) carbonate, manganese(II) hydroxide, manganese(II) oxide, oxides and hydroxides of iron.

10. The agent according to claim 1, wherein said spherical capsules range in diameter from about 0.2 mm and about 10 mm.

11. A method of preparing an agent for removing phosphorus compounds from water comprising, adding a biopolymer into a solution of a polyvalent metal compound and stirring, wherein drop-wise addition of the biopolymer and stirring at a constant rate forms capsules.

12. The method of claim 11, wherein said biopolymer or derivatives thereof with the ionic character is selected from a group consisting of alginate, κ-carrageenan, pectin, agar, guar gum, locust bean gum, and acacia gum.

13. The method of claim 11, wherein said biopolymer is produced microbiologically.

14. The biopolymer according to claim 13, wherein said microbiologically produced biopolymer is selected from a group consisting of xanthan, gellan and welan.

15. The method of claim 11, wherein said polyvalent metal compound is water soluble.

16. The method of claim 15, wherein said water soluble polyvalent metal compound is selected from the group consisting of calcium bicarbonate, calcium chloride, calcium nitrate(V), calcium acetate, calcium oxalate, calcium formate, iron(III) chloride, iron(II), iron(III) nitrate(V), iron(II) nitrate(V), iron(III) sulphate(VI), iron(II), iron(II) sulphate(VI), iron(II) oxalate, iron(II) acetate, iron(III) oxalate, zinc sulphate(VI), zinc chloride, zinc nitrate(V) and zinc acetate.

17. The method of claim 11, wherein said stirring rate ranged from about 500 rpm to 700 rpm.

18. The method of claim 11, wherein said capsules are substantially uniform, sphere shaped and range in diameter from about 0.2 mm to about 10 mm.

19. The method of claim 11, further comprising immobilizing a sparingly water soluble polyvalent metal compound in the capsules.

20. The method of claim 19, wherein said sparingly water soluble polyvalent metal compound is selected from the group consisting of calcium carbonate, calcium hydroxide, iron(II) carbonate, manganese(II) carbonate, manganese(II) hydroxide, manganese(II) oxide, oxides and hydroxides of iron.

21. A method of removing dissolved phosphorous compounds from water comprising, applying a polyvalent metal compound infused biopolymer capsules into water containing phosphorous compounds, wherein the polyvalent metal compound does not contain zirconium.
